(19) United States
(12) Patent Application Publication
(10) Pub. No.: US 2003/0001710 A1
(43) Pub. Date: Jan. 2, 2003

(54) Multi-layer radio frequency chip balun

(76) Inventors: Ching-Wen Tang, Nan-Tou City (TW); Jyh-Wen Sheen, Hsinchu (TW)

Correspondence Address: SUPREME PATENT SERVICES, POST OFFICE BOX 2339, SARATOGA, CA, 95070, US

(21) Appl. No.: 10/040,079

(22) Filed: Oct. 29, 2001

(30) Foreign Application Priority Data
Jun. 27, 2001 (TW) 90115631

(51) Int. Cl. H01F 5/00

(52) U.S. Cl. 336/200

(57) ABSTRACT

A multi-layer radio frequency chip balun comprises a multi-layer dielectric structure. The equivalent circuit of the multi-layer dielectric structure comprises mainly an input port, first and second output ports, and a few even sections of broadside coupled lines. Each section of the coupled line is wired in a particular shape and is composed of two coupled lines. Each section of coupled line corresponds to a coupled coefficient. The sections of the coupled lines have completely symmetric structures on two sides with respect to the center geometrically. Both phase and amplitude are well balanced at the balanced ports. Moreover, the balance of phase and power can be adjusted by inserting a transmission line between two broadside coupled lines to achieve more complicated impedance match. The balun can be fabricated with low dielectric constant materials. In addition to the reduction in cost, the stability of the balun is also improved. Therefore, the balun can be fabricated with a micro-chip size and suitably used in a wireless network or personal communication.

### FIELD OF THE INVENTION

The present invention generally relates to a balance-to-unbalance transformer (balun) used in a wireless local network or personal communication, and more specifically to a multi-layer radio frequency chip balun that can be fabricated as a device in a microchip.

### BACKGROUND OF THE INVENTION

A balun is a device for converting signals between an unbalanced circuit structure and a balanced circuit structure. The signal of a balanced circuit structure comprises two signal components with same amplitude but 180-degree phase difference. Many analog circuits require balanced inputs and outputs in order to reduce noise and high order harmonics as well as improve the dynamic range of the circuits.

There are several types of baluns that are either active or passive. Passive baluns can be classified as lumped-type, coil-type and distributed-type baluns. A lumped-type balun uses lumped capacitors and inductors to match impedance and generate two balanced signals with same amplitude but 180-degree phase difference. The advantages of a lumped-type balun are small volume and lightweight. However, it is not easy to maintain the 180-degree phase difference and the identical amplitude between the two signals.

Coil-type baluns have been widely used in lower frequency and ultra high frequency (UHF) bands. When a coil-type balun is used in higher than the UHF band, it usually has a drawback of having considerable loss. In addition, it has reached the limit of miniaturization and can not be further reduced in size.

Distributed-type baluns can further be classified as 180-degree hybrid and Marchand. A 180-degree hybrid balun has a fairly good frequency response in the microwave frequency band. However, its size often poses a problem when it is used in the radio frequency range between 200 MHz and several GHz. Because a 180-degree hybrid balun comprises a few sections of quarter wave transmission lines, it is difficult to reduce the size. Even if it is manufactured in a meandered way, a significant area is still required. One approach to reducing the size is to use a power divider along with a pair of transmission lines having different length for generating the 180-degree phase difference. Nevertheless, the size is still too large.

As shown in FIG. 1, a Marchand balun commonly used in the industry comprises two sections of quarter wave coupled lines. This type of baluns has a fairly large bandwidth. Both phase balance and power distribution of a Marchand balun are reasonably good. However, the transmission lines in a Marchand balun need to be tightly coupled in order to achieve a sufficient bandwidth. Therefore, a Marchand balun is often broadside coupled to reduce its area. It is also fabricated in a meandered way to minimize its size. The balun is commonly seen in an RF application. Using a high dielectric constant material can also reduce the size of a Marchand balun.

U.S. Pat. No. 5,497,137 discloses a chip-type transformer as shown in FIG. 2. The chip-type transformer comprises a laminate 200 formed by five dielectric substrates 214a-214e superimposed one on the other. A ground electrode 216 is formed on a main surface of the first dielectric substrate 214a. Another ground electrode 230 is formed on a main surface of the fifth dielectric substrate 214e. A connecting electrode 220 is formed on a main surface of the second dielectric substrate 214b.

There is a first strip line 222 on the third dielectric substrate 214c. The first strip line 222 comprises a first spiral portion 224a and a second spiral portion 224b that are electromagnetically coupled respectively to a second strip line 226 and a third strip line 228 formed on the fourth dielectric substrate 214d. The structure of the chip-type balun is broadside coupled and miniaturized by means of a high dielectric constant material. However, its size can not be reduced to a chip size if a low dielectric constant material is used.

### SUMMARY OF THE INVENTION

This invention has been made to overcome the above-mentioned drawbacks of conventional baluns. The primary object is to provide a multi-layer radio frequency chip balun. The multi-layer radio frequency chip balun comprises a multi-layer dielectric structure. The equivalent circuit of the multi-layer dielectric structure comprises mainly an input port, a first and a second output ports, and a few even sections of broadside coupled lines. Each section of the coupled line is wired in a particular shape and is composed of two coupled lines. Each section of coupled lines corresponds to a coupled coefficient. The sections of the coupled lines have completely symmetric structures on two sides with respect to the center geometrically. Both phase and amplitude are well balanced at the balanced ports.

According to this invention, the multi-layer radio frequency chip balun uses the ratio of coefficients of the coupled transmission lines to properly match the impedance at the balanced output ports. For example, by changing the line widths of the coupled transmission lines or the thickness of the layer, the impedance can be changed and the dimensions of the system can be reduced. Therefore, the overall dimension of the system designed by this invention is much smaller than that by Marchand balun. Moreover, the balance of phase and amplitude can be adjusted by inserting a trimming section of transmission lines between two coupled lines and can get a more complicated impedance match when the impedance values at the input and output ports are complex numbers. In addition, the balun of the invention can be realized with low dielectric constant materials to increase its stability. Therefore, the balun can be fabricated with a microchip size and suitably used in a wireless network or personal communication.

In the preferred embodiments of this invention, multiple sections of coupled lines can be incorporated. The coupled lines are manufactured with winding lines such as spiral lines, meandered lines, sinusoidal lines or saw-tooth lines. By means of winding lines, the area of the coupled lines is reduced.

There are six preferred embodiments illustrated in this invention. The first preferred embodiment uses coupled lines formed spirally and has low impedance at the balanced ports. Inserting a trimming section of transmission lines to this device can adjust the phase and amplitude balances between the balanced ports, and the impedance at the balanced output ports can be properly matched. The inserted transmission line trimming section can be capacitive or inductive.

The second preferred embodiment also uses coupled lines formed spirally and has a low impedance at the balanced ports. However, each terminal of the balanced ports is formed in a separate dielectric layer. Therefore, the location of the balanced ports is easier to design and the bandwidth is increased because the length of the transmission line is increased. Also, inserting a trimming section of transmission line to this device can adjust the phase and amplitude balances between the balanced ports, and the impedance at the balanced ports can be properly matched. The inserted transmission line trimming section can be capacitive or inductive.

The third preferred embodiment also uses coupled lines formed spirally and has a high impedance at the balanced ports.

The fourth preferred embodiment also uses coupled lines formed spirally and has a low impedance at the balanced ports. The fifth preferred embodiment also uses coupled lines formed spirally and has a high impedance at the balanced ports. Both embodiments use metal plates to connect to side-electrodes. Therefore, the width of the sections of broadside coupled line that originally needs to be wide is narrowed and the number of wiring is increased. If metal plates can not be connected to side-electrodes, the connection among ground planes and metal plates can be designed by via holes so that the width of sections of the broadside coupled line can be narrowed and the number of wiring can be increased.

The sixth preferred embodiment removes the inside grounded metal isolation layers in the balun structure shown in the above-mentioned five embodiments in order to reduce the number of layers and simplify the fabrication of components.

The operating efficiency of the baluns of this invention is analyzed based on the multi-layer circuit structures with and without grounded metal isolation layers. The results show that the amplitude difference is less than 0.5 dB and the phase difference is less than 3 degrees under the conditions of an operating frequency range 200 MHz and a center frequency 2.44 GHz.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 shows a schematic diagram of a conventional Marchand balun.

FIG. 2 shows a conventional chip-type balun.

FIG. 3 shows an equivalent circuit of the multi-layer radio frequency chip balun according to the first embodiment of this invention.

FIG. 4 shows another equivalent circuit of the multi-layer radio frequency chip balun by inserting a trimming section of transmission line to extend the circuit of FIG. 3.

FIGS. 5a-5d illustrate four examples of winding lines for forming the coupled lines of this invention including spiral lines, meandered lines, sinusoidal lines and saw-tooth lines.

FIG. 6a illustrates a multi-layer structure of a balun of the first preferred embodiment that uses coupled lines formed spirally and has a low impedance at the balanced ports.

FIG. 6b shows the insertion of an inductive trimming section of transmission line to the equivalent circuit of FIG. 6a.

FIG. 6c shows the insertion of a capacitive trimming section of transmission line to the equivalent circuit of FIG. 6a.

FIG. 7a illustrates a multi-layer structure of a balun of the second preferred embodiment that uses coupled lines formed spirally and has a low impedance at the balanced ports, wherein each terminal of the balanced ports is formed on a separate dielectric layer.

FIG. 7b shows the insertion of an inductive trimming section of transmission line to the equivalent circuit of FIG. 7a.

FIG. 7c shows the insertion of a capacitive trimming section of transmission line to the equivalent circuit of FIG. 7a.

FIG. 8 illustrates a multi-layer structure of a balun of the third preferred embodiment that uses coupled lines formed spirally and has a high impedance at the balanced ports.

FIG. 9a illustrates a multi-layer structure of a balun of the fourth preferred embodiment that uses coupled lines formed spirally and has a low impedance at the balanced ports, wherein metal plates are connected to side-electrodes and the balun device is grounded by side-metal.

FIG. 9b illustrates a multi-layer structure of a balun similar to that shown in FIG. 9a in which ground planes are connected through via holes to metal plates.

FIG. 10a illustrates a multi-layer structure of a balun of the fifth preferred embodiment that uses coupled lines formed spirally and has a high impedance at the balanced ports, wherein metal plates are connected to side-electrodes and the balun device is grounded by side-metal.

FIG. 10b illustrates a multi-layer structure of a balun similar to that shown in FIG. 10a in which ground planes are connected through via holes to metal plates.

FIG. 11 illustrates a multi-layer structure of a balun of the sixth preferred embodiment in which the inside grounded metal isolation layers are removed.

FIG. 12a shows the simulated results for the amplitude and phase differences at the balanced output ports of the equivalent circuit that contains the inside grounded metal isolation layers.

FIG. 12b shows the simulated results for the amplitude and phase differences at the balanced output ports of the equivalent circuit shown in FIG. 11

FIG. 13a shows the simulated results for the insertion loss and return loss of the equivalent circuit that contains the inside grounded metal isolation layers.

FIG. 13b shows the simulated results for the amplitude and phase differences at the balanced output ports of the equivalent circuit shown in FIG. 11.

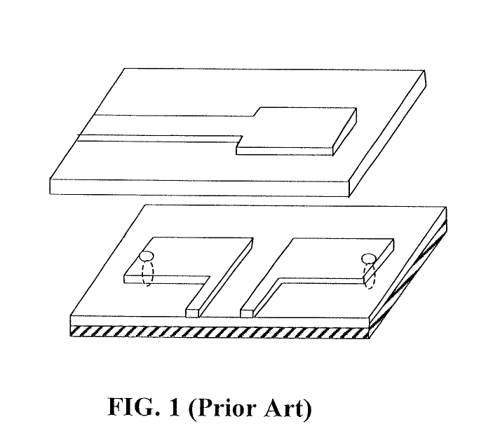

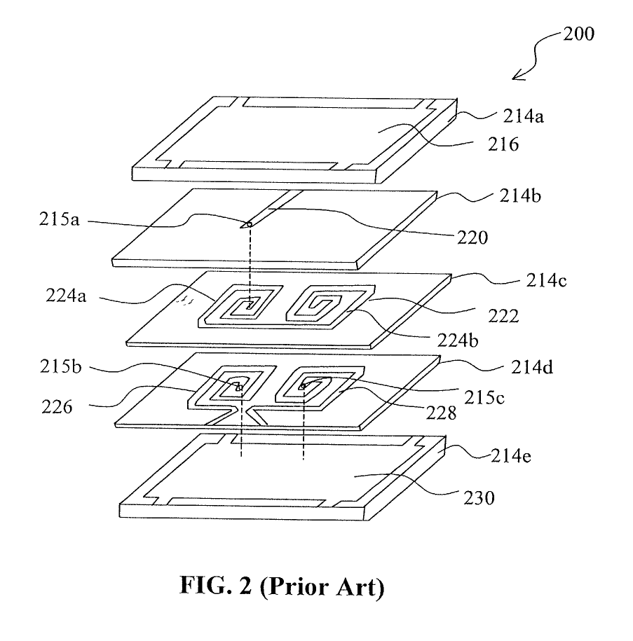

### DETAILED DESCRIPTION OF THE PREFERRED EMBODIMENTS

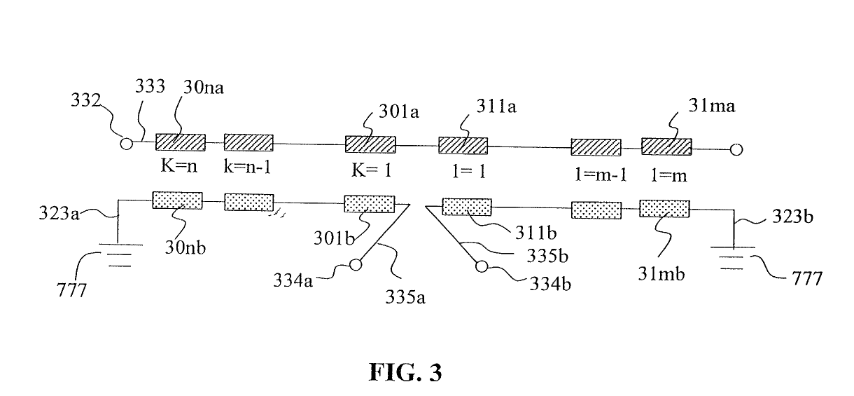

FIG. 3 shows the equivalent circuit of the multi-layer radio frequency chip balun 300 according to the first embodiment of this invention. The equivalent circuit of the multi-layer radio frequency chip balun basically comprises an unbalanced port 332, a first balanced port 334a, a second balanced port 334b, and a plurality of sections of broadside coupled lines 301 to 30n and 311 to 31m. Each section of broadside coupled lines corresponds to a coupled coefficient. The equivalent circuit shown in FIG. 3 comprises at least two different coupled coefficients. Each section of coupled lines comprises first and second coupled lines. The section of the broadside coupled line 301 includes the first coupled line 301a and the second coupled line 301b, and the section of the broadside coupled line 311 includes the first coupled line 311a and the second coupled line 311b, etc.

The unbalanced port 332 is an input terminal and two balanced ports 334a and 334b are output terminals. The left-hand side of the first balanced port 334a has n sections of broadside coupled lines 301 to 30n. The right-hand side of the second balanced port 334b has m sections of broadside coupled lines 311 to 31m. Each first coupled line of the middle sections is connected in series, and each second coupled line of the middle sections is connected similarly. The first balanced port 334a connects through a metal wire 335a to the coupled line 301b and the second balanced port 334b connects to the coupled line 311b through a metal wire 335b. The most left section 30n has its first coupled line 30na connected to the unbalanced port 332 through the strip line 333, and its second coupled line 30nb to the ground 777 through a metal wire 323a. The second coupled line 31mb of the most right section 31m is connected through a metal wire 323b to the ground 777, and its first coupled line 31ma is left open.

Except for the input terminal, the coupled lines have completely symmetric structures on two sides with respect to the center geometrically as illustrated in FIG. 3. Both phase and magnitude are well balanced at the balanced ports. By adjusting the width and the length of each section of broadside coupled lines or the thickness of each layer, the impedance at the balanced ports can be matched properly and the size of the device can be reduced. In practice, the broadside coupled lines in the first embodiment can be a symmetric or asymmetric structure.

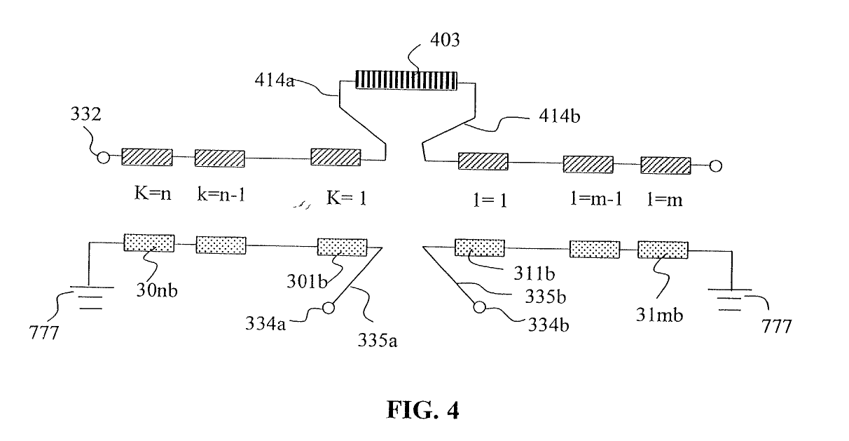

FIG. 4 shows another equivalent circuit of the multi-layer radio frequency chip balun by inserting a trimming section of transmission line between two coupled lines to extend the circuit of FIG. 3 according to the invention. In addition to increasing the phase and amplitude balances between the balanced ports, the complicated impedance between the balanced and unbalanced ports can also be properly matched when the impedance of the input/output terminals has a complex value. With reference to FIG. 4, the transmission line trimming section 403 has a first end connected to one end of the coupled line 301a through a strip line 414a, and a second end to one end of the coupled line 311a through a strip line 414b. In practice, the transmission line trimming section 403 can be capacitive or inductive.

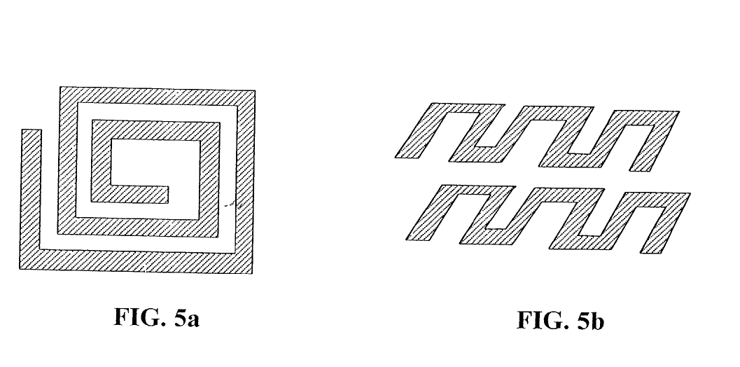

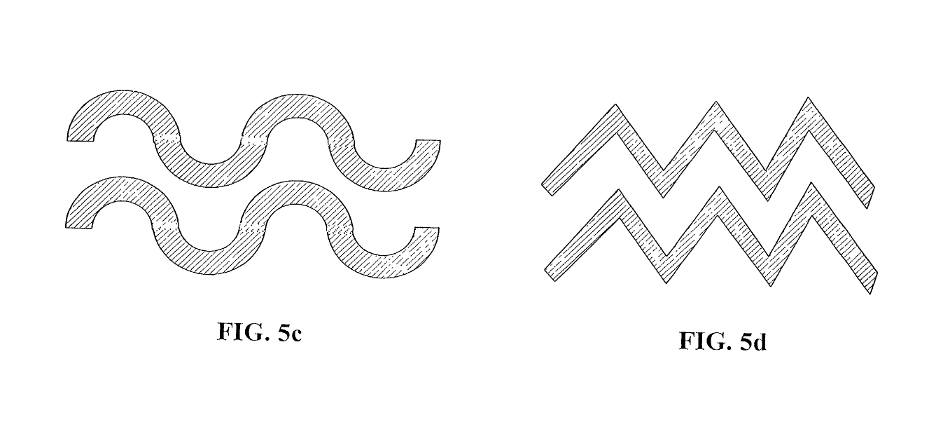

In the preferred embodiments of this invention, multiple sections of coupled lines can be incorporated. The coupled lines are manufactured with winding lines such as spiral lines, meandered lines, sinusoidal lines, and saw-tooth lines as illustrated in FIGS. 5a-5d. By means of these winding lines, the size of the balun can be reduced.

Because the coupled lines of this invention have symmetric structures on two sides with respect to the center geometrically, it is possible to reduce the size of the balun significantly by moving half of the symmetric structure above to form a structure which is also symmetric from top to bottom. A symmetric structure extending upwards and downwards can be formed to take advantage of a multi-layer structure and to reduce the size of the balun. The followings are several preferred embodiments of multi-layer structures that are symmetric from top to bottom.

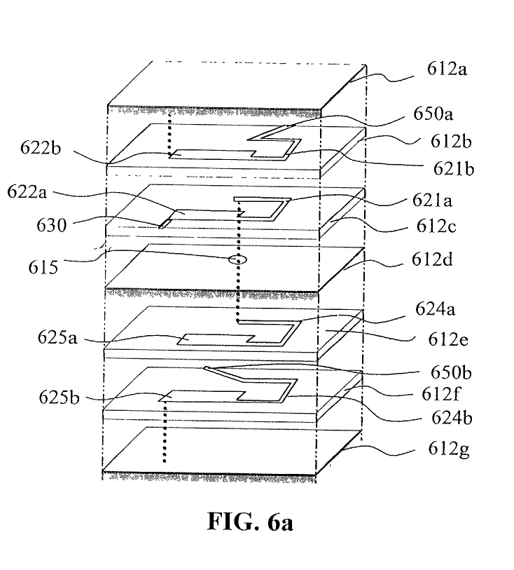

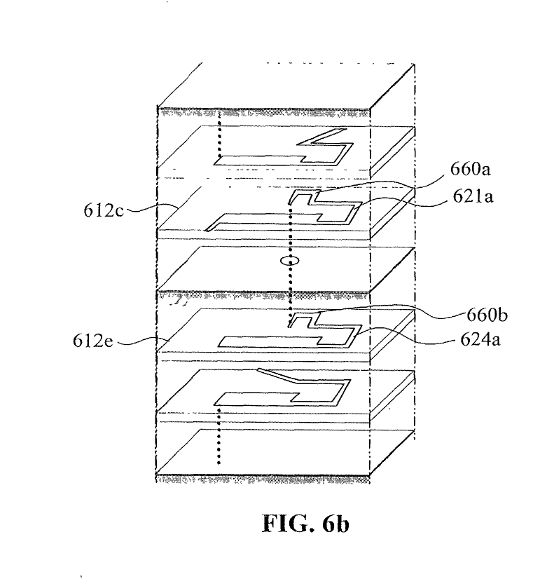

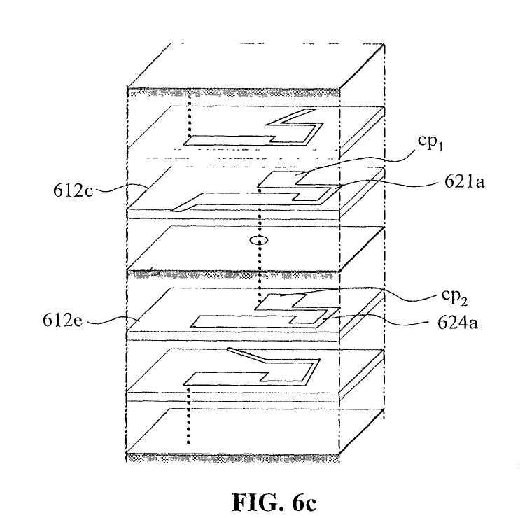

FIG. 6a shows the first preferred embodiment of a multi-layer radio frequency chip balun that has a low impedance at the balanced ports, wherein coupled lines are formed spirally according to this invention. As illustrated in FIG. 6a, the balun comprises seven dielectric substrates 612a-612g superimposed one on the other. The main surfaces of the first and seventh dielectric layers 612a and 612g are the first and second ground planes for the device respectively. These ground planes are formed by a metallic material.

The second coupled line 621b of the first section of broadside coupled lines, the second coupled line 622b of the second section of broadside coupled lines, and the first output port 650a are formed on the second dielectric layer 612b. The coupled line 622b is formed from the lower left side to the right side of a main surface and the coupled line 621b is formed on the right side of the main surface. The width of the coupled line 622b is wider than that of the coupled line 621b. As mentioned above, by adjusting the width and the length of each section of broadside coupled lines, the impedance at the balanced ports can be matched properly. The first output port 650a is formed on the upper right edge of the main surface. The coupled line 622b has one end connected to the coupled line 621b, and the other end to the first ground plane 612a as shown in dotted lines. The other end of the coupled line 621b is connected to the first output port 650a.

The second coupled line 624b of the third section of broadside coupled lines, the second coupled line 625b of the fourth section of broadside coupled lines, and the second output port 650b are formed on the sixth dielectric layer 612f. The coupled line 625b is formed from the lower left side to the right side of the main surface and the coupled line 624b is formed on the right side of the main surface. The width of the coupled line 625b is wider than that of the coupled line 624b. The second output port 650b is formed on the upper left edge of the main surface. The coupled line 625b has one end connected to the coupled line 624b and the other end to the second ground plane 612g as shown in dotted lines. The other end of the coupled line 624b is connected to the second output port 650b.

The first coupled line 621a of the first section of coupled lines, the first coupled line 622a of the second section of coupled lines, and the input port 630 are formed on the third dielectric layer 612c. The range of the coupled line 622a is from the lower left side to the right side of the main surface and the range of the coupled line 621a is from the right side to the center of the main surface. The width of the coupled line 622a is wider than that of the coupled line 621a. The input port 630 is formed on the lower left edge of the main surface. One end of the coupled line 622a is connected to one end of the coupled line 621a and the other end is connected to the input port 630.

The first coupled line 624a of the third section of coupled lines and the first coupled line 625a of the fourth section of coupled lines are formed on a main surface of the fifth dielectric layer 612e. The range of the coupled line 625a is from the lower left side to the right side of the main surface and the range of the coupled line 624a is from the right side to the center of the main surface. The width of the coupled line 625a is wider than that of the coupled line 624a. One end of the coupled line 625a is connected to one end of the coupled line 624a and the other end is left open.

The main surface of the fourth dielectric layer is a ground plane with a via hole 615. The ground plane is formed by a metallic material. The coupled lines 624a and 621a are connected through the via hole 615 as shown in dotted lines. All coupled lines in this device are formed spirally.

FIGS. 6b and 6c show two other embodiments of the multi-layer radio frequency chip balun by inserting a trimming section of transmission line between two coupled lines in the equivalent circuit of FIG. 6a according to the invention. In addition to increasing the phase and amplitude balance between the balanced ports, the complicated impedance between the balanced and unbalanced ports can also be properly matched when the impedance of the input/output terminals is complex. In practice, the inserted transmission line trimming section can be capacitive or inductive. FIGS. 6b and 6c show the insertion of an inductive and a capacitive trimming section of transmission line to the equivalent circuit of FIG. 6a respectively. Referring to FIG. 6b, the inserted inductive transmission line trimming section is formed on a main surface of the fifth dielectric layer 612e and on a main surface of the third dielectric layer 612c. It has one end connected to the coupled line 621a through the strip line 660a, and the other end to the coupled line 624a through the strip line 660b. Referring to FIG. 6c, the inserted capacitive transmission line trimming section is formed on a main surface of the fifth dielectric layer 612e and on a main surface of the third dielectric layer 612c. It has a first electrode CP₁ connected to the coupled line 621a, and a second electrode CP₂ to the coupled line 624a.

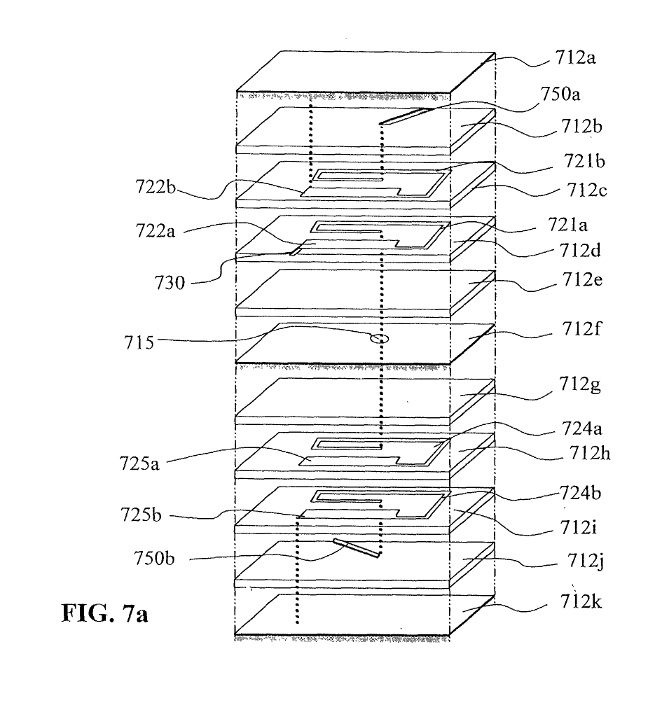

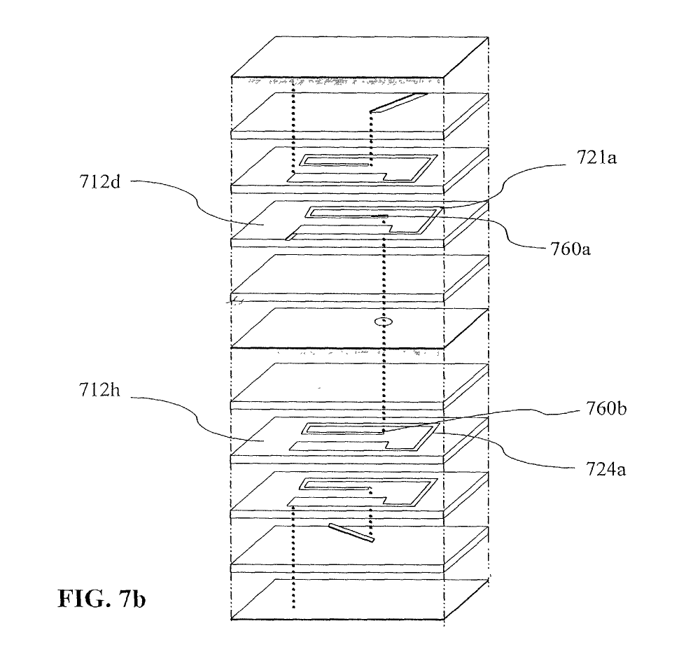

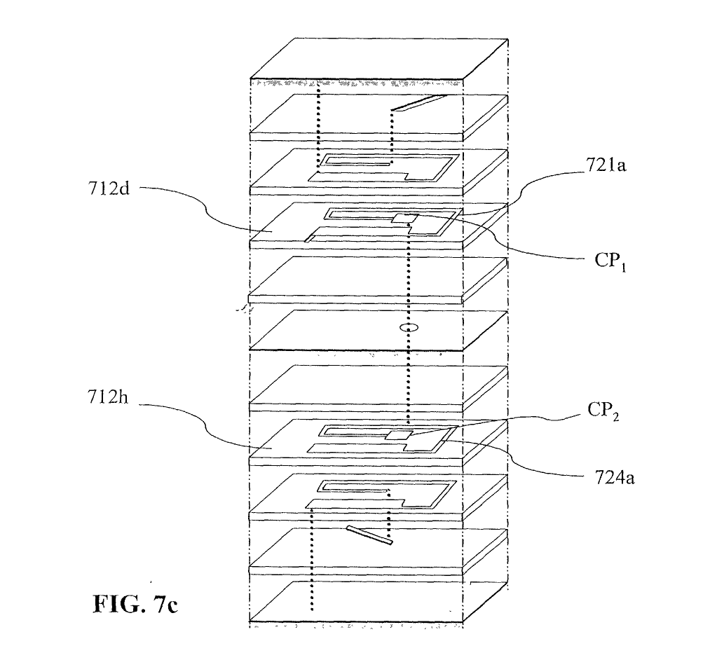

FIG. 7a shows the second preferred embodiment of a multi-layer radio frequency chip balun that has a low impedance at the balanced ports and coupled lines are formed spirally according to this invention. Each terminal of the balanced ports is formed on a separate dielectric layer. Therefore, the location of the balanced ports is easier to design and the bandwidth is increased because the length of the transmission line is increased.

Referring to FIG. 7a, the balun comprises eleven dielectric substrates 712a-712k superimposed one on the other. The main surfaces of the first and eleventh dielectric layers 712a and 712k are the first and second ground planes for the device respectively. These ground planes are formed by a metallic material.

A first output port 750a is formed on the second dielectric layer 712b. The range of the first output port 750a is from the center to the upper right edge of the main surface. A second output port 750b is formed on the tenth dielectric layer 712j. The range of the second output port 750b is from the center to the upper left edge of the main surface.

The second coupled line 721b of the first section of broadside coupled lines and the second coupled line 722b of the second section of broadside coupled lines are formed on the third dielectric layer 712c. The coupled line 722b is formed from the lower left side to the right side of the main surface. The width of the coupled line 722b is wider than that of the coupled line 721b. One end of the coupled line 722b is connected to one end of the coupled line 721b and the other end is connected to the first ground plane 712a as shown in dotted lines. The other end of the coupled line 721b is connected to the first output port 750a as shown in dotted lines.

The second coupled line 724b of the third section of broadside coupled lines and the second coupled line 725b of the fourth section of broadside coupled lines are formed on the ninth dielectric layer 712i. The coupled line 725b is formed from the lower left side to the right side of the main surface. The width of the coupled line 725b is wider than that of the coupled line 724b. One end of the coupled line 725b is connected to one end of the coupled line 724b and the other end is connected to the second ground plane 712k as shown in dotted lines. The other end of the coupled line 724b is connected to the second output port 750b as shown in dotted lines.

The first coupled line 721a of the first section of coupled lines, the first coupled line 722a of the second section of coupled lines, and the input port 730 are formed on the fourth dielectric layer 712d. The range of the coupled line 722a is from the lower left side to the right side of the main surface and the range of the coupled line 721a is from the right side to the center of the main surface. The width of the coupled line 722a is wider than that of the coupled line 721a. The input port 730 is formed on the lower left edge of the main surface. One end of the coupled line 722a is connected to one end of the coupled line 721a and the other end is connected to the input port 730.

The first coupled line 724a of the third section of coupled lines and the first coupled line 725a of the fourth section of coupled lines are formed on a main surface of the eighth dielectric layer 712h. The range of the coupled line 725a is from the lower left side to the right side of the main surface and the range of the coupled line 724a is from the right side to the center of the main surface. The width of the coupled line 725a is wider than that of the coupled line 724a. One end of the coupled line 725a is connected to one end of the coupled line 724a and the other end is left open.

The main surfaces of the fifth and seventh dielectric layers 712e and 712g has no circuit on them. The main surface of the sixth dielectric layer 712f as illustrated is a ground plane with a via hole 715. The ground plane is formed by a metallic material. The coupled lines 724a and 721a are connected through the via hole 715 as shown in dotted lines. All coupled lines in this device are formed spirally.

Similarly, FIGS. 7b and 7c show two other embodiments of the multi-layer radio frequency chip balun by inserting a trimming section of transmission line to the equivalent circuit of FIG. 7a according to the invention. In addition to increasing the phase and power balances between the balanced ports, the complicated impedance between the balanced and unbalanced ports can also be properly matched when the impedance of the input/output terminals is complex. In practice, the inserted transmission line trimming section can be capacitive or inductive. FIGS. 7b and 7c show the insertion of an inductive and a capacitive trimming section of transmission line to the equivalent circuit of FIG. 7a respectively. Referring to FIG. 7b, the inserted inductive transmission line trimming section is formed on a main surface of the fourth dielectric layer 712d and on a main surface of the eighth dielectric layer 712h. It has one end connected to the coupled line 721a through the strip line 760a, and the other end connected to the coupled line 724a through the strip line 760b. Referring to FIG. 7c, the inserted capacitive transmission line trimming section is formed on a main surface of the fourth dielectric layer 712d and on a main surface of the eighth dielectric layer 712h. It has a first electrode CP₁ connected to the coupled line 721a and a second electrode CP₂ connected to the coupled line 724a.

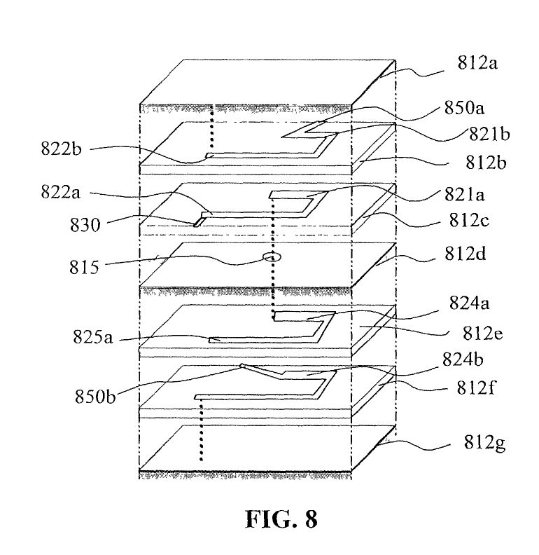

FIG. 8 shows the third preferred embodiment of a multi-layer radio frequency chip balun that has a high impedance at the balanced ports, wherein coupled lines are formed spirally according to this invention. The balun shown in FIG. 8 is similar to the balun shown in FIG. 6a except that the widths of the coupled lines are different. As illustrated in FIG. 8, the balun also comprises seven dielectric substrates 812a-812g superimposed one on the other. The main surfaces of the first and seventh dielectric layers 812a and 812g are the first and second ground planes of the device respectively. These ground planes are formed by a metallic material.

The second coupled line 821b of the first section of broadside coupled lines, the second coupled line 822b of the second section of broadside coupled lines, and the first output port 850a are formed on the second dielectric layer 812b. The coupled line 822b is formed from the lower left side to the right side of the main surface and the coupled line 821b is formed on the right side of the main surface. The width of the coupled line 821b is wider than that of the coupled line 822b. As mentioned above, by adjusting the width and the length of each section of broadside coupled lines, the impedance at the balanced ports can be matched properly. The first output port 850a is formed on the upper right edge of the main surface. The coupled line 822b has one end connected to coupled line 821b, and the other end to the first ground plane 812a as shown in dotted lines. The other end of the coupled line 821b is connected to the first output port 850a.

The second coupled line 824b of the third section of broadside coupled lines, the second coupled line 825b of the fourth section of broadside coupled lines, and the second output port 850b are formed on the sixth dielectric layer 812f. The coupled line 825b is formed from the lower left side to the right side of the main surface and the coupled line 824b is formed on the right side of the main surface. The width of the coupled line 824b is wider than that of the coupled line 825b. The second output port 850b is formed on the upper left edge of the main surface. The coupled line 825b has one end connected to the coupled line 824b, and the other end to the second ground plane 812g as shown in dotted lines. The other end of the coupled line 824b is connected to the second output port 850b.

The first coupled line 821a of the first section of coupled lines, the first coupled line 822a of the second section of coupled lines, and the input port 830 are formed on the third dielectric layer 812c. The range of the coupled line 822a is from the lower left side to the right side of the main surface and the range of the coupled line 821a is from the right side to the center of the main surface. The width of the coupled line 821a is wider than that of the coupled line 822a. The input port 830 is formed on the lower left edge of the main surface. The coupled line 822a has one end connected to the coupled line 821a, and the other end to the input port 830.

The first coupled line 824a of the third section of coupled lines and the first coupled line 825a of the fourth section of coupled lines are formed on a main surface of the fifth dielectric layer 812e. The range of the coupled line 825a is from the lower left side to the right side of the main surface and the range of the coupled line 824a is from the right side to the center of the main surface. The width of the coupled line 824a is wider than that of the coupled line 825a. One end of the coupled line 825a is connected to one end of the coupled line 824a and the other end is left open.

The main surface of the fourth dielectric layer is a ground plane with a via hole 815. The ground plane is formed by a metallic material. The coupled lines 824a and 821a are connected through the via hole 815 as shown in dotted lines. All coupled lines in this device are formed spirally.

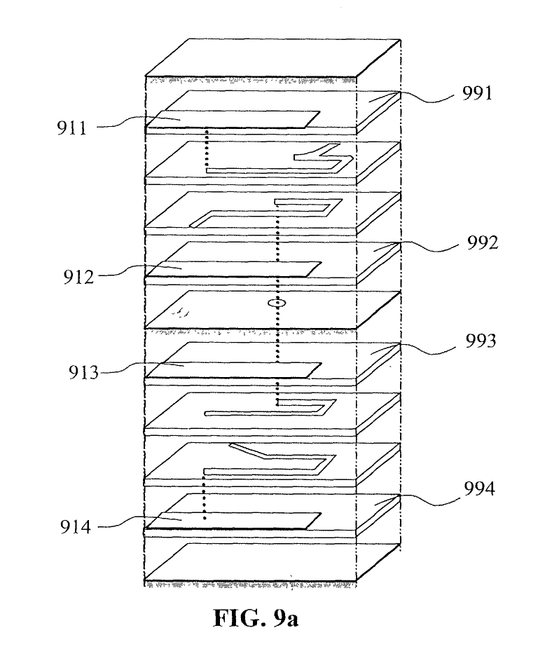

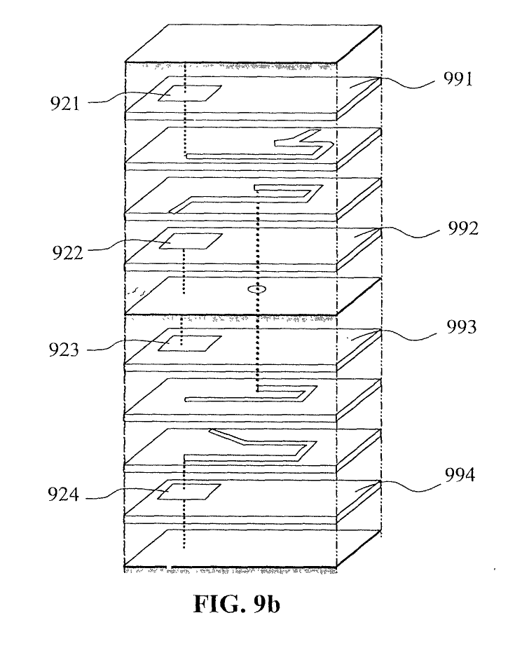

FIG. 9a shows the fourth preferred embodiment of a multi-layer radio frequency chip balun that has low impedance at the balanced ports. Metal plates 911-914 are connected to side-electrodes 991-994 and the balun device is grounded by side-metal. Therefore, the widths of sections of broadside coupled lines that originally need to be wide can be narrowed and the number of wiring can be increased.

Under the circumstances that metal plates in the multi-layer structure shown in FIG. 9a can not be connected to side-electrodes, the connection among ground planes and metal plates can be designed by via holes so that the widths of sections of broadside coupled lines can be narrowed and the number of wiring can be increased, as shown in FIG. 9b. Referring to FIG. 9b, metal plates 921-924 are connected to ground planes through via holes.

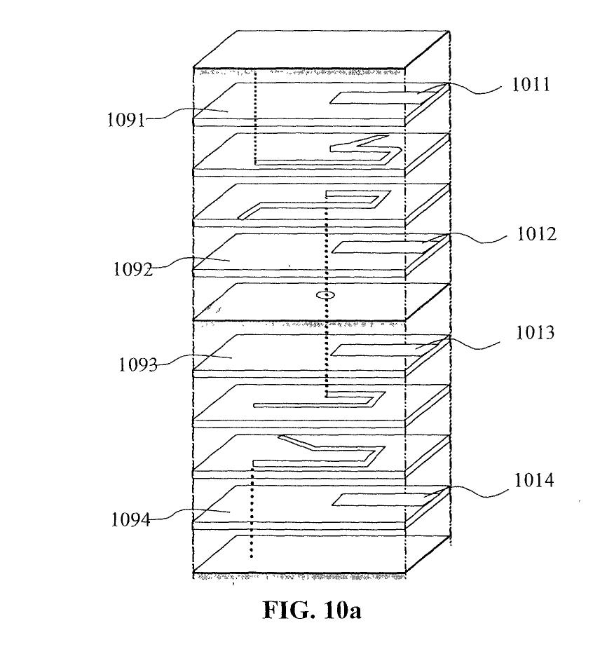

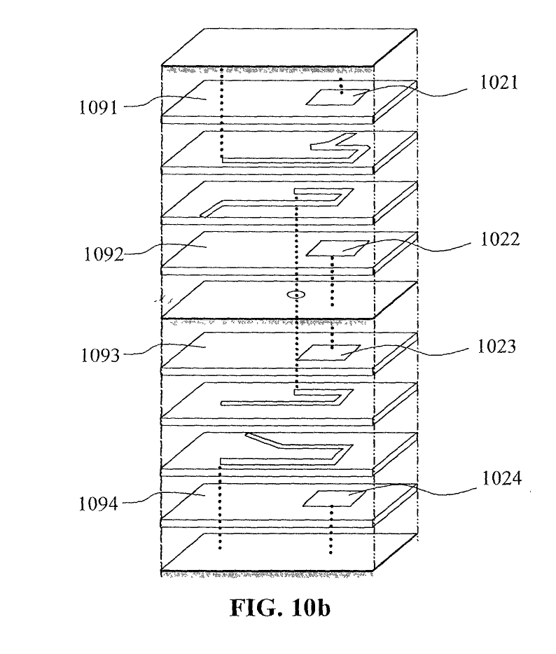

FIG. 10a shows the fifth preferred embodiment of a multi-layer radio frequency chip balun that has high impedance at the balanced ports. Metal plates 1011-1014 are connected to side-electrodes 1091-1094 and the balun device is grounded by side-metal. Therefore, the widths of sections of broadside coupled lines that originally need to be wide can be narrowed and the number of wiring can be increased.

Similarly, if metal plates in the multi-layer structure shown in FIG. 10a can not be connected to side-electrodes, the connection among ground planes and metal plates can also be designed by via holes so that the width of sections of broadside coupled line can be narrowed and the number of wiring can be increased, as shown in FIG. 10b. Referring to FIG. 10b, metal plates 1021-1024 are connected to ground planes through via holes.

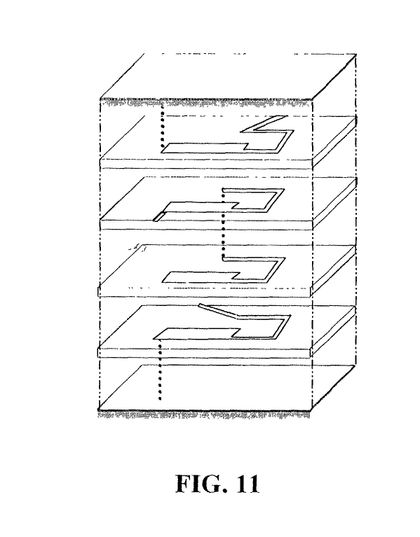

In order to reduce the number of layers and simplify the fabrication of components, the inside grounded metal isolation layers in the balun structure shown in the above-mentioned five embodiments can be removed. Only the first and second ground planes are left, as shown in FIG. 11.

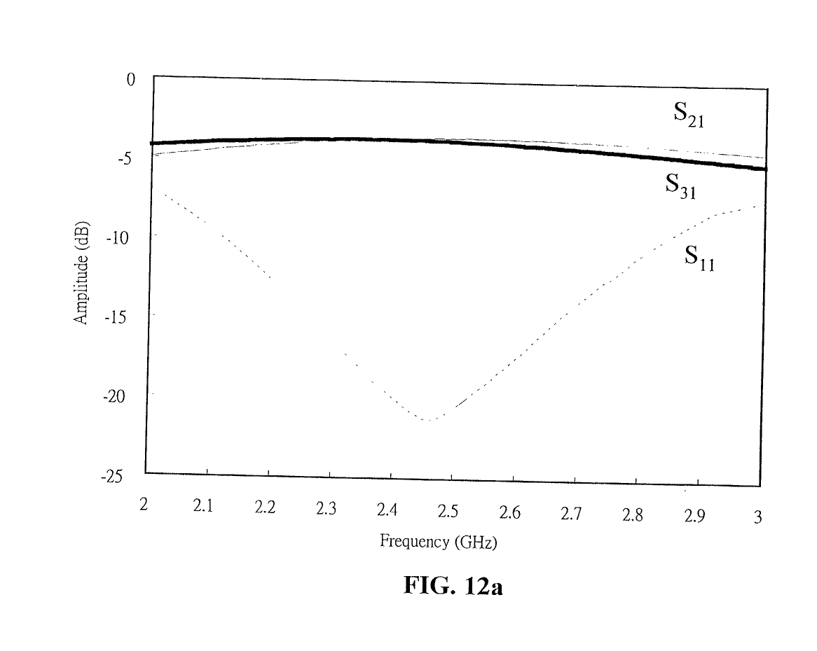

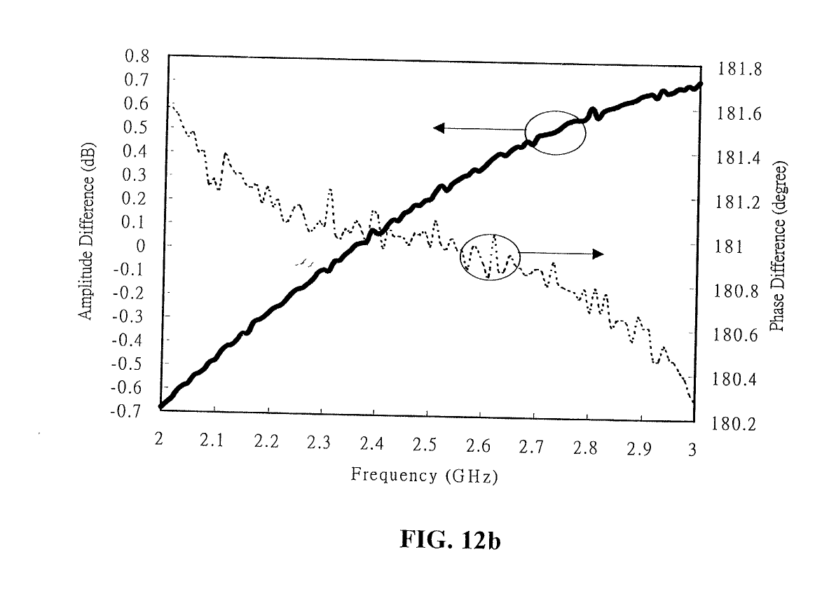

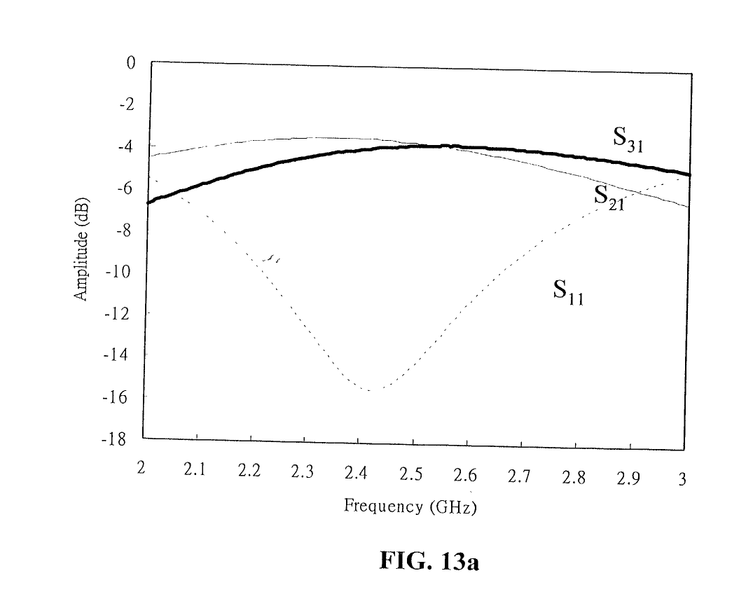

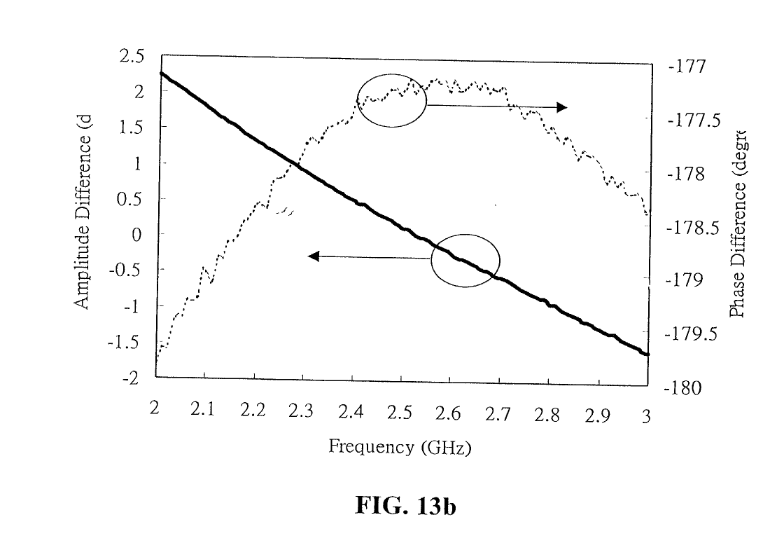

In the present invention, the preferred material for forming the coupled lines, transmission lines, or ground planes is a low loss metallic material such as Ag, Pd, Cu, Au, or Ni. Assuming a ceramic dielectric constant ∈ᵣ=7.8 and a center frequency f₀=2.44 GHz, the operating efficiency of the baluns of this invention is analyzed based on the multi-layer circuit structures with and without grounded metal isolation layers. The characteristics for the return loss S₁₁ as well as the insertion losses S₂₁ and S₃₁ are measured and shown in FIGS. 12a and 13a for the circuits of FIGS. 3 and 4 respectively. In the figures, the vertical axis is the amplitude of the measured loss in dB. The horizontal axis shows the operating frequency of the balun from 2 to 3 GHz.

In a high frequency circuit, the measured voltage and current are fluctuated like waves whose values may vary with locations. To characterize a circuit using the scattering parameter (S parameter), the impedance characteristic of the transmission line connected to each port has to be preset. The return loss S₁₁ should be less than −10 dB in the designed frequency range, i.e., 2.34-2.54 GHz. As can be seen from FIGS. 12a and 13a, the return loss is less than −10 dB that means that the balun has good impedance match and the energy loss is very small. As far as the insertion losses S₂₁ and S₃₁, the energy should be distributed equally in the two ports with some loss due to the material. The loss shown in FIGS. 12a and 13a is less than −3 dB that indicates that the energy has been equally distributed and the balanced ports receive most of the energy.

FIGS. 12b and 13b show the measured differences in amplitude and phase within the operating frequency range for the two circuits. The horizontal axis is the operating frequency of the balun in GHz. The vertical axis shows the differences in degree and dB for phase and amplitude respectively. As can be seen, within an operating frequency range 200 MHz, the amplitude difference is less than 0.5 dB and the phase difference is less than 3 degrees.

According to the multi-layer radio frequency chip balun of the invention, the drawbacks of the conventional baluns have been overcome. The size of the device has been significantly reduced and the operating frequency bandwidth is increased. The impedance between the balanced and unbalanced ports can be matched properly. The device can be fabricated with low dielectric constant materials. In addition to the reduction in cost, the stability of the device is also improved. Therefore, the baluns of this invention can be fabricated with a micro-chip size and suitably used in a wireless network or personal communication.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A radio frequency chip balun comprising:
an input port;
first and second output ports;
a first group of at least one section of coupled lines, each section of said first group corresponding to a coupled coefficient and having first and second coupled lines, the first coupled line of each section in said first group being connected in series to form a first string of first coupled lines, the second coupled line of each section in said first group being connected in series between said first output port and ground; and
a second group of at least one section of coupled lines, each section of said second group corresponding to a coupled coefficient and having first and second coupled lines, the first coupled line of each section in said second group being connected in series to form a second string of first coupled lines, the second coupled line of each section in said second group being connected in series between said second output port and ground;
wherein the first string of first coupled lines and the second string of first coupled lines are connected in series between said input port and an open terminal.

2. The radio frequency chip balun as claimed in claim 1, comprising at least two sections of coupled lines having different coupled coefficients.

3. The radio frequency chip balun as claimed in claim 1, wherein each coupled line in a section of coupled lines has a shape of a spiral line, meandered line, sinusoidal line or saw-tooth line.

4. The radio frequency chip balun as claimed in claim 1, wherein each coupled line in a section of coupled lines is made of a low loss metal.

5. The radio frequency chip balun as claimed in claim 1, wherein said balun is formed by a multi-layer dielectric structure.

6. The radio frequency chip balun as claimed in claim 5, said multi-layer dielectric structure having at least seven vertically stacked dielectric layers comprising:
a first dielectric layer having a main surface formed with a ground plane;
a second dielectric layer having a main surface formed with the second coupled line of a first section of coupled lines of said first group, the second coupled line of a second section of coupled lines of said first group, and said first output port;
a third dielectric layer having a main surface formed with the first coupled line of the first section of coupled lines of said first group, the first coupled line of the second section of coupled lines of said first group, and said input port;
a fourth dielectric layer having a main surface formed with a ground plane and a via hole;
a fifth dielectric layer having a main surface formed with the first coupled line of a first section of coupled lines of said second group and the first coupled line of a second section of coupled lines of said second group;
a sixth dielectric layer having a main surface formed with the second coupled line of the first section of coupled lines of said second group, the second coupled line of the second section of coupled lines of said second group, and said second output port; and
a seventh dielectric layer having a main surface formed with a ground plane.

7. The radio frequency chip balun as claimed in claim 6, wherein the second coupled line of the second section of coupled lines of said first group is extended from a lower left side toward a lower right side of the main surface of said second dielectric layer, the second coupled line of the first section of coupled lines of said first group is formed on a right side of the main surface of said second dielectric layer, the second coupled line of the second section of coupled lines of said second group is extended from a lower left side toward a lower right side of the main surface of said sixth dielectric layer, the second coupled line of the first section of coupled lines of said second group is formed on a right side of the main surface of said sixth dielectric layer, the first coupled line of the second section of coupled lines of said first group is extended from a lower left side toward a lower right side of the main surface of said third dielectric layer, the first coupled line of the first section of coupled lines of said first group is formed on a right side of the main surface of said third dielectric layer, the first coupled line of the second section of coupled lines of said second group is extended from a lower left side toward a lower right side of the main surface of said fifth dielectric layer, and the first coupled line of the first section of coupled lines of said second group is formed on a right side of the main surface of said fifth dielectric layer.

8. The radio frequency chip balun as claimed in claim 6, wherein in said first and second groups, the width of the coupled lines in the second section of coupled lines is wider than the width of the coupled lines in the first section of coupled lines.

9. The radio frequency chip balun as claimed in claim 6, wherein the second coupled line of the second section of coupled lines on said second dielectric layer has a first end connected to a first end of the second coupled line of the first section of coupled lines on said second dielectric layer and a second end connected to said first dielectric layer through a via hole, a second end of the second coupled line of the first section of coupled lines on said second dielectric layer is connected to said first output port, the second coupled line of the second section of coupled lines on said sixth dielectric layer has a first end connected to a first end of the second coupled line of the first section of coupled lines on said sixth dielectric layer and a second end connected to said seventh dielectric layer through a via hole, a second end of the second coupled line of the first section of coupled lines on said sixth dielectric layer is connected to said second output port, the first coupled line of the second section of coupled lines on said third dielectric layer has a first end connected to the first coupled line of the first section of coupled lines on said third dielectric layer and a second end connected to said input port, the first coupled line of said second section of coupled lines on said fifth dielectric layer has a first end connected to the first coupled line of the first section of coupled lines on said fifth dielectric layer, and the first coupled line of the first section of coupled lines on said third dielectric layer is connected to the first coupled line of said first section of coupled lines on said fifth dielectric layer through said via hole on said fourth dielectric layer.

10. The radio frequency chip balun as claimed in claim 5, said multi-layer dielectric structure having at least six vertically stacked dielectric layers comprising:
a first dielectric layer having a main surface formed with a metal ground plane;
a second dielectric layer having a main surface formed with the second coupled line of a first section of coupled lines of said first group, the second coupled line of a second section of coupled lines of said first group, and said first output port;
a third dielectric layer having a main surface formed with the first coupled line of the first section of coupled lines of said first group, the first coupled line of the second section of coupled lines of said first group, and said input port;
a fourth dielectric layer having a main surface formed with the first coupled line of a first section of coupled lines of said second group and the first coupled line of a second section of coupled lines of said second group;
a fifth dielectric layer having a main surface formed with the second coupled line of the first section of coupled lines of said second group, the second coupled line of the second section of coupled lines of said second group, and said second output port; and
a sixth dielectric layer having a main surface formed with a metal ground plane.

11. The radio frequency chip balun as claimed in claim 5, said multi-layer dielectric structure having at least eleven vertically stacked dielectric layers comprising:
a first dielectric layer having a main surface formed with a ground plane;
a second dielectric layer having a main surface formed with said first output port;
a third dielectric layer having a main surface formed with the second coupled line of the first section of coupled lines of said first group and the second coupled line of the second section of coupled lines of said first group;
a fourth dielectric layer having a main surface formed with the first coupled line of the first section of coupled lines of said first group, the first coupled line of the second section of coupled lines of said first group, and said input port;
a fifth dielectric layer having a main surface formed with a ground plane;
a sixth dielectric layer having a main surface formed with a ground plane and a via hole;
a seventh dielectric layer having a main surface formed with a ground plane;
an eighth dielectric layer having a main surface formed with the first coupled line of the first section of coupled lines of said second group and the first coupled line of the second section of coupled lines of said second group;
a ninth dielectric layer having a main surface formed with the second coupled line of the first section of coupled lines of said second group and the second coupled line of the second section of coupled lines of said second group;
a tenth dielectric layer having a main surface formed with said second output port; and
an eleventh dielectric layer having a main surface formed with a ground plane.

12. The radio frequency chip balun as claimed in claim 11, wherein said ground planes are formed by a metallic material.

13. The radio frequency chip balun as claimed in claim 5, said multi-layer dielectric structure having at least nine vertically stacked dielectric layers comprising:
a first dielectric layer having a main surface formed with a ground plane;
a second dielectric layer having a main surface formed with said first output port;
a third dielectric layer having a main surface formed with the second coupled line of
the first section of coupled lines of said first group and the second coupled line of the second section of coupled lines of said first group;
a fourth dielectric layer having a main surface formed with the first coupled line of the first section of coupled lines of said first group, the first coupled line of the second section of coupled lines of said first group, and said input port;
a fifth dielectric layer having a main surface formed with a ground plane and a via hole;
a sixth dielectric layer having a main surface formed with the first coupled line of the first section of coupled lines of said second group and the first coupled line of the second section of coupled lines of said second group;
a seventh dielectric layer having a main surface formed with the second coupled line of the first section of coupled lines of said second group and the second coupled line of the second section of coupled lines of said second group;
an eighth dielectric layer having a main surface formed with said second output port; and
a ninth dielectric layer having a main surface formed with a ground plane.

14. The radio frequency chip balun as claimed in claim 5, said multi-layer dielectric structure having at least eleven vertically stacked dielectric layers comprising:
a first dielectric layer having a main surface formed with a ground plane;
a second dielectric layer having a main surface formed with a metal plate;
a third dielectric layer having a main surface formed with the second coupled line of a first section of coupled lines of said first group, the second coupled line of a second section of coupled lines of said first group, and said first output port;
a fourth dielectric layer having a main surface formed with the first coupled line of the first section of coupled lines of said first group, the first coupled line of the second section of coupled lines of said first group, and said input port;
a fifth dielectric layer having a main surface formed with a metal plate;
a sixth dielectric layer having a main surface formed with a ground plane and a via hole;
a seventh dielectric layer having a main surface formed with a metal plate;
an eighth dielectric layer having a main surface formed with the first coupled line of a first section of coupled lines of said second group and the first coupled line of a second section of coupled lines of said second group;
a ninth dielectric layer having a main surface formed with the second coupled line of the first section of coupled lines of said second group, the second coupled line of the second section of coupled lines of said second group, and said second output port;
a tenth dielectric layer having a main surface formed with a metal plate; and
an eleventh dielectric layer having a main surface formed with a ground plane.

15. The radio frequency chip balun as claimed in claim 14, wherein said metal plates on said second, fifth, seventh and tenth dielectric layers are connected to side electrodes and said blaun is grounded by said side metal.

16. The radio frequency chip balun as claimed in claim 14, wherein said metal plates on said second, fifth, seventh and tenth dielectric layers are connected through via holes to ground planes.

17. A radio frequency chip balun comprising:
an input port;
first and second output ports;
a transmission line having first and second ends;
a first group of at least one section of coupled lines, each section of said first group corresponding to a coupled coefficient and having first and second coupled lines, the first coupled line of each section in said first group being connected in series between said input port and the first end of said transmission line, the second coupled line of each section in said first group being connected in series between said first output port and ground; and
a second group of at least one section of coupled lines, each section of said second group corresponding to a coupled coefficient and having first and second coupled lines, the first coupled line of each section in said second group being connected in series between the second end of said transmission line and an open terminal, the second coupled line of each section in said second group being connected in series between said second output port and ground.

18. The radio frequency chip balun as claimed in claim 17, wherein said transmission line is capacitive.

19. The radio frequency chip balun as claimed in claim 17, wherein said transmission line is inductive.

20. The radio frequency chip balun as claimed in claim 17, wherein each coupled line in a section of coupled lines has a shape of a spiral line, meandered line, sinusoidal line or saw-tooth line.

21. The radio frequency chip balun as claimed in claim 17, wherein each coupled line in a section of coupled lines is made of a low loss metal.

22. The radio frequency chip balun as claimed in claim 17, wherein said transmission line is made of a low loss metal.

23. The radio frequency chip balun as claimed in claim 17, wherein said balun is formed by a multi-layer dielectric structure.

24. The radio frequency chip balun as claimed in claim 23, said multi-layer dielectric structure having at least seven vertically stacked dielectric layers comprising:
a first dielectric layer having a main surface formed with a ground plane;
a second dielectric layer having a main surface formed with the second coupled line of a first section of coupled lines of said first group, the second coupled line of a second section of coupled lines of said first group, and said first output port;
a third dielectric layer having a main surface formed with the first coupled line of the first section of coupled lines of said first group, the first coupled line of the second section of coupled lines of said first group, said input port, and a first section of said transmission line;
a fourth dielectric layer having a main surface formed with a ground plane and a via hole;
a fifth dielectric layer having a main surface formed with the first coupled line of a first section of coupled lines of said second group, the first coupled line of a second section of coupled lines of said second group, and a second section of said transmission line;
a sixth dielectric layer having a main surface formed with the second coupled line of the first section of coupled lines of said second group, the second coupled line of the second section of coupled lines of said second group, and said second output port; and
a seventh dielectric layer having a main surface formed with a ground plane.

25. The radio frequency chip balun as claimed in claim 24, wherein the second coupled line of the second section of coupled lines of said first group is extended from a lower left side toward a lower right side of the main surface of said second dielectric layer, the second coupled line of the first section of coupled lines of said first group is formed on a right side of the main surface of said second dielectric layer, the second coupled line of the second section of coupled lines of said second group is extended from a lower left side toward a lower right side of the main surface of said sixth dielectric layer, the second coupled line of the first section of coupled lines of said second group is formed on a right side of the main surface of said sixth dielectric layer, the first coupled line of the second section of coupled lines of said first group is extended from a lower left side toward a lower right side of the main surface of said third dielectric layer, the first coupled line of the first section of coupled lines of said first group is formed on a right side of the main surface of said third dielectric layer, the first coupled line of the second section of coupled lines of said second group is extended from a lower left side toward a lower right side of the main surface of said fifth dielectric layer, and the first coupled line of the first section of coupled lines of said second group is formed on a right side of the main surface of said fifth dielectric layer.

26. The radio frequency chip balun as claimed in claim 24, wherein in said first and second groups, the width of the coupled lines in the second section of coupled lines is wider than the width of the coupled lines in the first section of coupled lines.

27. The radio frequency chip balun as claimed in claim 24, wherein the second coupled line of the second section of coupled lines on said second dielectric layer has a first end connected to a first end of the second coupled line of the first section of coupled lines on said second dielectric layer and a second end connected to said first dielectric layer through a via hole, a second end of the second coupled line of the first section of coupled lines on said second dielectric layer is connected to said first output port, the second coupled line of the second section of coupled lines on said sixth dielectric layer has a first end connected to a first end of the second coupled line of the first section of coupled lines on said sixth dielectric layer and a second end connected to said seventh dielectric layer through a via hole, a second end of the second coupled line of the first section of coupled lines on said sixth dielectric layer is connected to said second output port, the first coupled line of the second section of coupled lines on said third dielectric layer has a first end connected to a first end of the first coupled line of the first section of coupled lines on said third dielectric layer and a second end connected to said input port, the first coupled line of the first section of coupled lines on said third dielectric layer has a second end connected to the first section of said transmission line on said third dielectric layer, the first coupled line of said second section of coupled lines on said fifth dielectric layer has a first end connected to a first end of the first coupled line of the first section of coupled lines on said fifth dielectric layer, the first coupled line of the first section of coupled lines on said fifth dielectric layer has a second end connected the second section of said transmission line on said fifth dielectric layer, and the first section of said transmission line on said third dielectric layer is connected to the second section of said transmission line on said fifth dielectric layer through said via hole on said fourth dielectric layer.

28. The radio frequency chip balun as claimed in claim 23, said multi-layer dielectric structure having at least eleven vertically stacked dielectric layers comprising:
a first dielectric layer having a main surface formed with a ground plane;
a second dielectric layer having a main surface formed with said first output port;
a third dielectric layer having a main surface formed with the second coupled line of the first section of coupled lines of said first group and the second coupled line of the second section of coupled lines of said first group;
a fourth dielectric layer having a main surface formed with the first coupled line of the first section of coupled lines of said first group, the first coupled line of the second section of coupled lines of said first group, a first section of said transmission line, and said input port;
a fifth dielectric layer having a main surface formed with a ground plane;
a sixth dielectric layer having a main surface formed with a ground plane and a via hole;
a seventh dielectric layer having a main surface formed with a ground plane;
an eighth dielectric layer having a main surface formed with the first coupled line of the first section of coupled lines of said second group, the first coupled line of the second section of coupled lines of said second group, and a second section of said transmission line;
a ninth dielectric layer having a main surface formed with the second coupled line of the first section of coupled lines of said second group and the second coupled line of the second section of coupled lines of said second group;
a tenth dielectric layer having a main surface formed with said second output port; and
an eleventh dielectric layer having a main surface formed with a ground plane.

29. The radio frequency chip balun as claimed in claim 28, wherein said ground planes are formed by a metallic material.

30. The radio frequency chip balun as claimed in claim 23, said multi-layer dielectric structure having at least six vertically stacked dielectric layers comprising:
a first dielectric layer having a main surface formed with a metal ground plane;
a second dielectric layer having a main surface formed with the second coupled line of a first section of coupled lines of said first group, the second coupled line of a second section of coupled lines of said first group, and said first output port;
a third dielectric layer having a main surface formed with the first coupled line of the first section of coupled lines of said first group, the first coupled line of the second section of coupled lines of said first group, a first section of said transmission line and said input port;
a fourth dielectric layer having a main surface formed with the first coupled line of a first section of coupled lines of said second group, the first coupled line of a second section of coupled lines of said second group, and a second section of said transmission line;
a fifth dielectric layer having a main surface formed with the second coupled line of the first section of coupled lines of said second group, the second coupled line of the second section of coupled lines of said second group, and said second output port; and
a sixth dielectric layer having a main surface formed with a metal ground plane.

31. The radio frequency chip balun as claimed in claim 23, said multi-layer dielectric structure having at least nine vertically stacked dielectric layers comprising:
a first dielectric layer having a main surface formed with a ground plane;
a second dielectric layer having a main surface formed with said first output port;
a third dielectric layer having a main surface formed with the second coupled line of the first section of coupled lines of said first group and the second coupled line of the second section of coupled lines of said first group;
a fourth dielectric layer having a main surface formed with the first coupled line of the first section of coupled lines of said first group, the first coupled line of the second section of coupled lines of said first group, a first section of said transmission line, and said input port;
a fifth dielectric layer having a main surface formed with a ground plane and a via hole;
a sixth dielectric layer having a main surface formed with the first coupled line of the first section of coupled lines of said second group, the first coupled line of the second section of coupled lines of said second group, and a second section of said transmission line;
a seventh dielectric layer having a main surface formed with the second coupled line of the first section of coupled lines of said second group and the second coupled line of the second section of coupled lines of said second group;
a eighth dielectric layer having a main surface formed with said second output port; and
a ninth dielectric layer having a main surface formed with a ground plane.
